(19) United States
(12) Patent Application Publication
(10) Pub. No.: US 2005/0068951 A1
(43) Pub. Date: Mar. 31, 2005

(54) Protocol for video communications and camera control

(76) Inventors: Alain Rivard, Kanata (CA); Eric Boisvert, Kanata (CA); George Chamberlain, Kanata (CA)

Correspondence Address: BLAKE, CASSELS & GRAYDON, LLP, 45 O'CONNOR ST., 20TH FLOOR, OTTAWA, ON, K1P 1A4, CA

(21) Appl. No.: 10/787,096

(22) Filed: Feb. 27, 2004

(30) Foreign Application Priority Data
Sep. 29, 2003 (CA) 2,443,351

(51) Int. Cl. H04L 12/56

(52) U.S. Cl. 370/389

(57) ABSTRACT

This invention relates in general to data communications, and in particular, to the delivery of video over a data network. It discloses a communications protocol for use with high performance imaging systems networks providing multi-point-to-multi-point connection between the video sources and the receiving host. The protocol is useful for imaging systems that deliver all the video information reliability in real time to the receiving host.

### FIELD OF INVENTION

This invention relates in general to data communications, and in particular, to the delivery of video over a data network.

### BACKGROUND OF THE INVENTION

High performance imaging systems have traditionally been implemented using specialized equipment with a single point-to-point connection between the video source and the receiving PC due to the high throughput and processing requirements on the image data. These systems, which are high cost, are characterized by their need to deliver all the video information reliability in real time.

With the advent of networked information systems, there is a need to provide compatibility between information systems and imaging systems and reduce cost. Gigabit Ethernet provides the means to deliver this compatibility while simultaneously reducing cost through the use of standard, rather than specialized, equipment and cabling.

As well, Gigabit Ethernet, makes it possible to access the camera's video information from multiple locations and remotely controlling the camera via the IP link. Existing Internet Protocols (IP) such as Transmission Control Protocol (TCP), User Datagram Protocol (UDP) and Real-time Protocol (RTP) are limited in their applicability to managing these communications.

TCP provides a high reliability connection, but with a hefty communications overhead since the receipt of every packet must be confirmed. Any packets not delivered cause later packets to be discarded and be resent.

UDP provides a high throughput connection, but provides no validation that all the data has been received and has no facilities to handle time-outs, retransmission and duplicate detection.

RTP attempts to correct these deficiencies by incorporating the high throughput benefit of UDP with the ability to deliver real time data streams with timestamp information. RTP does not provide the ability to retransmit data, so is not suitable for reliable high-performance video transmission where every packet of information must be delivered.

Therefore, there is a need for a method to deliver video over a standard transmission media reliably at Gigabit rates and above.

### SUMMARY OF THE INVENTION

The object of the current invention is to provide a reliable method to deliver high performance video over point-to-point connections and shared multiple access networks, while also providing the means to control the video source.

The communications method provides the capability to send large segments of data reliably while using a base transport protocol, such as UDP, that does not provide handshaking. The communications method inherits the capabilities of the network and transport mechanisms used for the transmittal. For example, if a broadcast, or multicast, to multiple destinations is permitted with the underlying protocols available, the communications method can take advantage of this feature.

As well, the facility to relay commands and status information, either with or separately from the video data, is provided. The ability to transmit interrupts either to or from the video source is also provided.

The communications method consists of a variety of headers that are used to convey information back and forth, including a command header, a data header, an answer header, and an interrupt header.

The command header provides the means to send commands, known as actions, to a remote device or devices.

The data header provides the means to send data to a remote device or devices. The data header provides the means to include a timestamp, data IDs for data reconstruction, and identifiers to tag the type of data, including regular data and re-send data.

The answer header provides the means to provide a response to received commands.

The interrupt header provides a means to assert interrupts on a remote device. The device can be a video source, computer, or any other device connected on the network, either directly or indirectly through a connected device.

One skilled in the art will recognize that additional types of data, not just video, could be sent using this communications method.

### BRIEF DESCRIPTION OF THE DRAWINGS

FIG. 1 Command Header Fields.

FIG. 2 Command Header Field Descriptions.

FIG. 3 Command Header Action Types.

FIG. 4 Get Device Info Command Header Action Fields.

FIG. 5 Get Device Info Command Header Action Field Description.

FIG. 6 Get Device Info Action Reply.

FIG. 7 Image Trigger Command Header Action Fields.

FIG. 8 Image Trigger Command Header Action Field Descriptions.

FIG. 9 Re-send Image Packet Command Header Action Fields.

FIG. 10 Resound Image Packet Command Header Action Field Descriptions.

FIG. 11 Module Reset Command Header Action Fields.

FIG. 12 Module Reset Command Header Action Field Descriptions.

FIG. 13 Answer Header Format.

FIG. 14 Answer Format Field Descriptions.

FIG. 15 Data Format Header.

FIG. 16 Data Format Field Descriptions.

FIG. 17 Interrupt Header Format.

FIG. 18 Interrupt Header Field Descriptions.

FIG. 19 Communications Process For Receiving Data.

### DETAILED DESCRIPTION OF THE PREFERRED EMBODIMENT

The following detailed description of the embodiments makes reference to the accompanying drawings, which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical, and electrical changes may be made without departing from the spirit and scope of the present inventions. The following detailed description is, therefore, not to be taken in a limiting sense, and the scope of the present inventions is defined only by the appended claims.

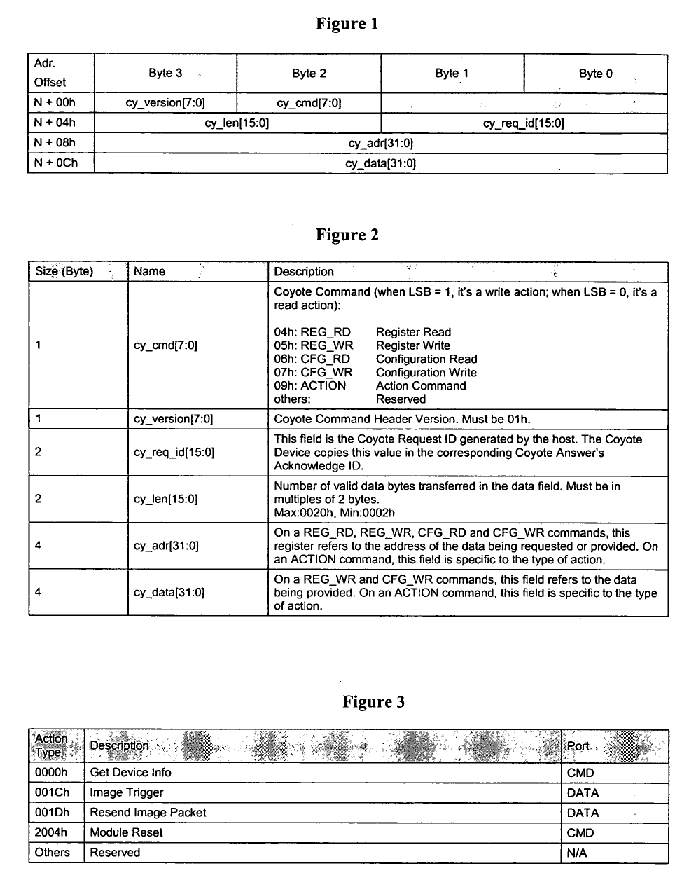

The communications protocol provides the ability to send commands to a remote device. The command format is presented in FIG. 1 and the field descriptions for the command header are provided in FIG. 2. The command header includes a number of different fields. A single byte command instruction, cy_cmd, is provided at byte two of the command header to identify the command being transmitted. Bytes one and zero have been left open to provide for future expansion of the command set. Extra bytes can be allocated to the Command Header, and to any other header, beyond those described for future expansion of the communication protocol.

Cy_cmd is an extendable list of command codes. Typical commands are those to perform register reads and writes from the remote device, configuration reads and writes, and action commands. A register read/write provides access to the remote device functions, such as the ability to configure or query the video source or connected camera. The configuration commands provide access to the communications engine to configure or query its settings, and the action command is used to signify a specific action is to be taken. Those skilled in the art will recognize that other commands are possible.

Cy_version contains the version of the command header, thus allowing devices using different versions of the communications protocol to communicate. Devices equipped to communicate with the most recent version of the header provide backwards compatibility to communicate with devices using any of the older versions of the communication method if they are present.

Cy_req_id provides an ID number for the command request. Optionally, acknowledgements can be provided for commands if the device configuration settings are set-up to provide confirmation. Confirmation of packets received is only available for commands, so as not to reduce the performance when sending data. The acknowledgement provides the request ID such that the source device can correlate the return acknowledgement to the source command packet.

Since the header length can be variable, cy_len provides the length of the header to facilitate the algorithms to process the header.

The last two fields of the Command header are the address and the data for configuration and register reads and writes. These fields are multi-purpose and are replaced with different fields when an action is chosen as the cy_command.

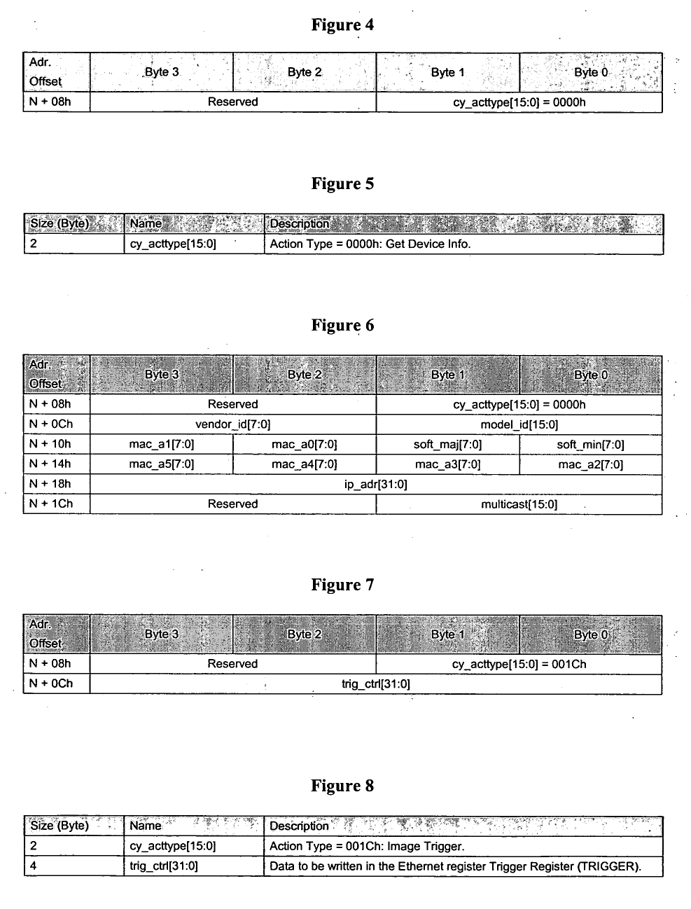

Some possible Command Header action types are defined in FIG. 3 and shown in FIG. 4. Up to 65K actions on multiple ports are supported.

All actions and command acknowledgements use the Answer Header format which is shown in FIG. 13. Similar to the Command Header, the first two bytes of the header are available for future expansion.

The Get Device Info action, shown in FIG. 5, requests information about the remote device. The answer format to a Get Device Info request is provided in FIG. 6.

In the Answer Header (shown in FIG. 13) the command is echoed back, along with the acknowledgement ID. A status is also reported which, when all zeros, indicates success. Bits are provided to report errors. The status supports up to 256 return values.

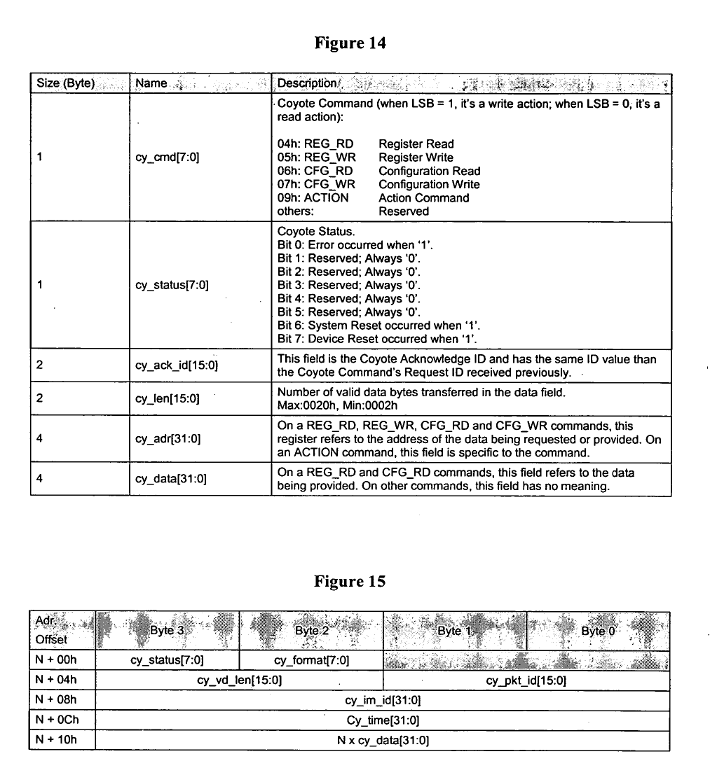

When the Answer Header contains the result of a Get Device Info Action, the address and data fields of the Answer Header are replaced with the collected information from the remote device. The fields for the Answer Header are set out in FIG. 14.

With reference to FIG. 6, the expected answer of the Get Device Info contains the vendor id which is a 16 bit code, and can be broken down into sub-identities, for uniquely identifying the device. A separate 16-bit model id is provided. The device also provides software revision information, media access controller (MAC) address, and IP address. A multicast identifier number is also provided if the device is part of a multicast group.

It should be noted that multiple Get Device Info actions can be created to provide different levels of details of a single device, or to provide different types of details for multiple devices.

The Image Trigger action, whose header is set out in FIG. 7 and whose fields are depicted in FIG. 8, causes image data to be acquired upon receipt of the trigger.

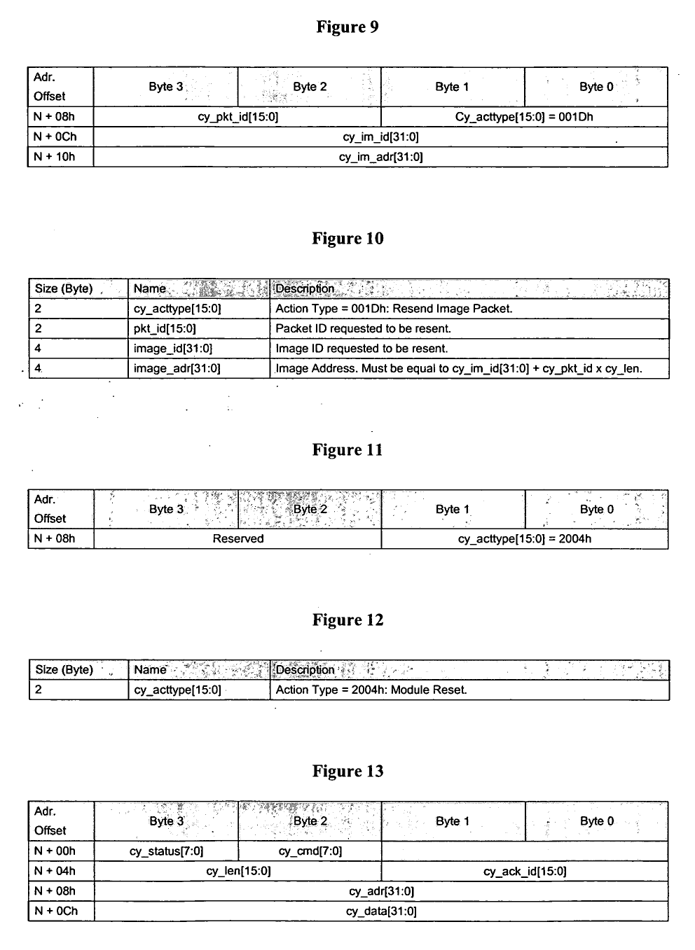

The Re-send Image Packet action, shown in FIG. 9, provides the ability to request image data to be resent. As shown in FIG. 15, all image packets are sent with an identifier number. This allows the receiving device to recognize whether image packets are missing without having to perform handshaking on every packet exchange. The handshaking only occurs when necessary.

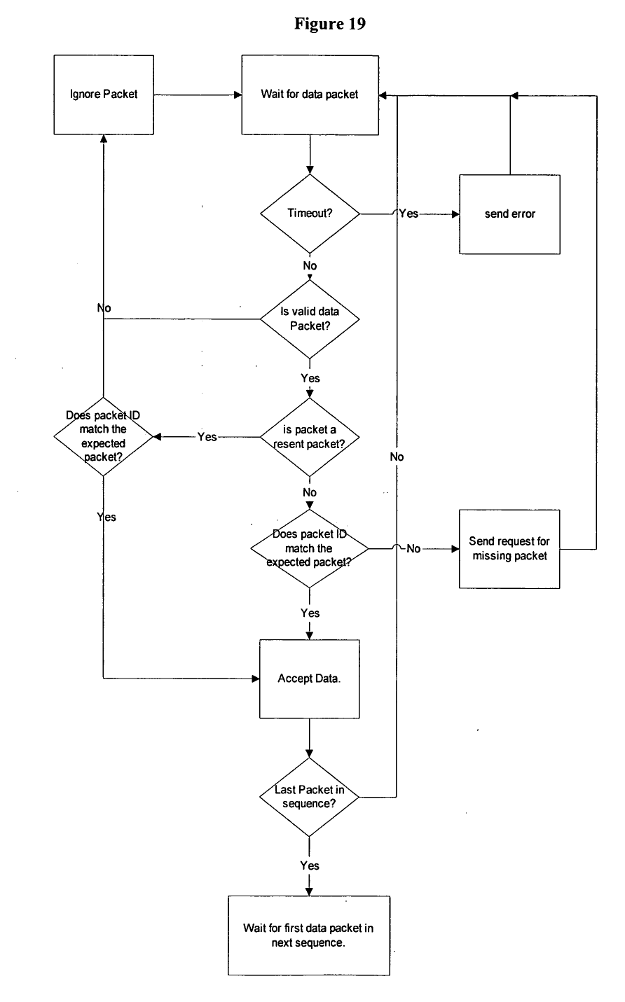

The communication process for receiving data is shown in FIG. 19.

When a packet is discovered missing, the packet identifiers which uniquely identify the missing packet and its location in the image (image_adr or image address) are sent back to the source device. This combination of information permits the data to be automatically fetched from memory without the sending computer needing to perform a search for the missing data. The packet's location in memory can be simply computed based on the relative address in the Re-send Image Packet request.

The Module Reset action request header is presented in FIG. 11 and its fields are presented in FIG. 12. Upon receipt of a module reset request, the receiving device immediately performs a reset.

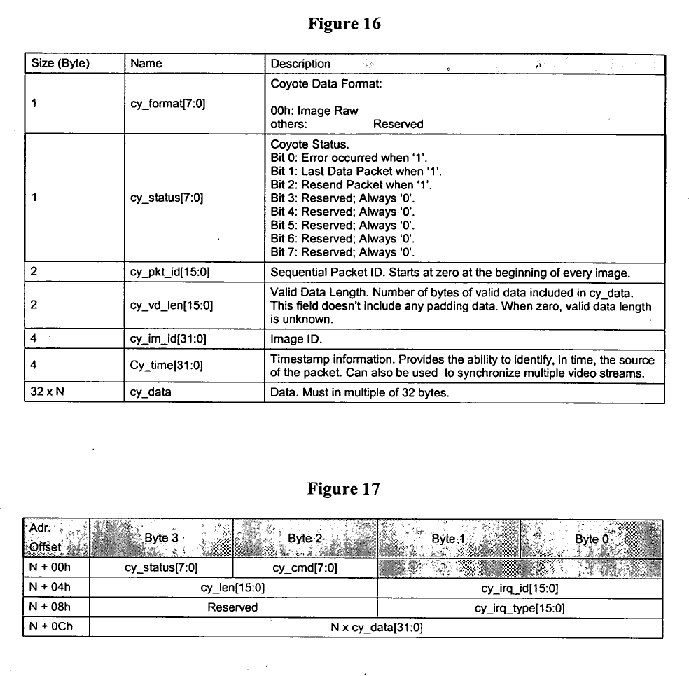

The Data Header message, shown in FIG. 15, provides the means to send video data. The fields are presented in FIG. 16. The video header provides the ability to handle 256 video types. The type definition ensures that the receiving device treats the data appropriately. The data can be raw image data, compressed images, an audio stream, multimedia, or any other type of data. Data format definition is very flexible. With a cy_format, it is possible to define a data format comprised of a mix of data and commands such that the command header, or any other header, is inserted in the packet in a known location. Through the cy_format code, the receiving device can interpret the data appropriately, executing or interpreting the command information and routing the actual data to the appropriate location.

To ensure that all the data has been received, a sequential packet identifier is provided (cy_pkt_id), which is incremented with every video packet sent. Since this is not sufficient for synchronizing multiple image sources or tracing back an image packet to a known transmittal time, the cy_time field is provided so that a 32-bit timestamp can be sent.

With this scheme, it is possible to ensure that all transmitted image packets are received with handshaking only required when there is a lost packet or an error in communication (provided with the cy_status field).

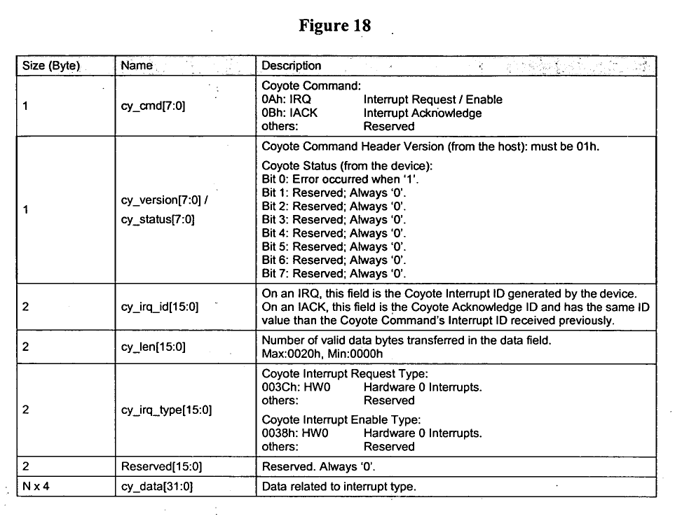

The Interrupt Header format and fields are described in FIGS. 17 and 18 respectively. Using this header, interrupts can be invoked on the remote device through the network. The same header is used for interrupt requests and acknowledgements. Like the other headers, it is extendable, and natively accommodates 65K interrupts and 65K interrupt types. Any data related to the interrupt or interrupt acknowledge can be transferred with the header, and is reflected in cy_len.

It is to be understood that this description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

The embodiment(s) of the invention described above is (are) intended to be exemplary only. The scope of the invention is therefore intended to be limited solely by the scope of the appended claims.

1. A message structure providing a communications protocol for use over a high speed network to control a video source, the message structure having a message header selected from one of:
(i) a command header;
(ii) a data header; and
(iii) an answer header.

2. The communications protocol message structure of claim 1 further including a selected message header that is an interrupt header.

3. The communications protocol message structure of claim 1, where the vidoe source being controlled provides image data.

4. The communications protocol message structure of claim 1, wherein a message having a command header further includes data fields defining:
(i) a command code;
(ii) request ID;
(iii) a message length;
(iv) a command address; and
(v) command data.

5. The communications protocol message structure of claim 2, further including a data field defining a version.

6. The communications protocol message structure of claim 2, wherein the data field defining the command code provides unique codes corresponding to a register read command, a register write command, a configuration read command, and a configuration write command.

7. The communications protocol message structure of claim 2, wherein the data field defining the command code provides a unique code corresponding to an action command.

8. The communications protocol message structure of claim 2, wherein the command code data field provides unique codes corresponding to a get device info action command; a trigger action command and a re-send packet action command.

9. The communications protocol message structure of claim 8, wherein the command code data field further provides a unique code corresponding to a module reset action command.

10. The communications protocol message structure of claim 1, wherein a message having a data header further includes data fields defining:
a packet ID; and
a data ID.

11. The communications protocol message structure of claim 10, wherein a message having a data header has unique valuetags for a regular message and a re-send message data types.

12. The communications protocol message structure of claim 6, wherein a network node receiving a message containing a command header produces a response message containing an answer header.

13. The protocol of claim 10, wherein a message having a data header further includes the data fields defining:
(i) data length;
(ii) a time stamp; and
(iii) resent image.

14. The protocol of claim 10, further including a format code whereby different types of data can be uniquely identified.

15. The protocol of claim 1, further including an identifier number.

16. A method for communicating data over a network comprising:
providing a source of image packets, each such packet including an identifier number; and
providing a receiver of image packets to process a series of image packets; and
tracking the receiving image package identifier number;
producing re-send image packet request for packets not successfully received.
